(19) United States
(12) Patent Application Publication
(10) Pub. No.: US 2010/0030989 A1
(43) Pub. Date: Feb. 4, 2010

(54) STORAGE MANAGEMENT METHOD AND STORAGE CONTROL APPARATUS

(75) Inventors: Kazuo NAKASHIMA, Kawasaki (JP); Osamu Kimura, Kawasaki (JP); Minoru Muramatsu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/512,252

(22) Filed: Jul. 30, 2009

(30) Foreign Application Priority Data
Jul. 31, 2008 (JP) 2008-198900

(51) Int. Cl. G06F 12/16

(52) U.S. Cl. 711/162; 711/E12.103

(57) ABSTRACT

A storage control apparatus that stores backup target in a predetermined storage area of a storage apparatus includes a determination unit for determining whether or not the backup target data has been modified, and a backup processing unit for performing the backup processing for the backup target data when the determination unit determines that the backup target data has been modified.

### CROSS-REFERENCE TO RELATED APPLICATIONS

This application is based upon and claims the benefit of priority of the prior Japanese Patent Application No. 2008-198900, filed on Jul. 31, 2008, the entire contents of which are incorporated herein by reference.

### FIELD

Embodiments of the present invention relate to a storage control apparatus, a storage management method using the same, and a storage system including the same.

### BACKGROUND

A mass storage system using a storage apparatus with a disk array such as of magnetic disks is widely in use. The process of powering off such a storage system is typically started by a user performing an operation such as pressing a power button for power-on/off. At power-off, power is turned off after backup target data requiring backup processing is saved as backup data in a predetermined storage area, e.g., a system disk. This allows the same state as before the power-off to be kept at the next power-on of the apparatus. Also, in such a storage system, what is called a memory backup function is essential for stable operation with higher reliability. For this purpose, a backup battery is usually provided. When AC supply to the storage system is suddenly shut off, for example at the occurrence of a power failure, memory in which data requiring backup is held during the power failure is continuously powered by the backup battery. Therefore, when the AC supply is recovered, the memory data being held can be used to keep the same state as before the shutoff of the AC supply. The AC supply means power supply from outside the storage apparatus.

One such method of powering off by a conjunction of the host and the storage system involves the use of power supply tap control.

FIG. 11 is a diagram showing exemplary power-off operations, particularly illustrating a case where power-off operations according to the above-described standard procedure are performed. This standard procedure is as described in (1) to (4) below. Reference numeral 1 in FIG. 11 denotes a storage system.

(1) First, a host 2 is given an OFF instruction from an operator.

(2) The host 2 performs power-off based on the instruction.

(3) The power-off by the host 2 in (2) causes a stoppage of AC consumption through an outlet.

(4) A certain time after the stoppage of the AC consumption in (3), AC supply to a storage control apparatus 3 and a storage apparatus 4 is stopped by the power supply tap control.

In this case, data in a table area, such as management information, is backed up in memory by a battery.

Known techniques related to the present invention include a technique of saving the content of memory on a storage medium in a short time at a power failure of an information processing apparatus (Japanese Patent Laid-Open No. 10-63586), and a technique of shortening the saving time in a semiconductor disk device by saving a block that has not been updated in a nonvolatile storage device in advance (Japanese Patent Laid-Open No. 6-4228).

Using the standard procedure shown in FIG. 11, power-off of the storage system may be a power failure caused by the AC-off (a pseudo power failure), rather than user-instructed power-off, i.e., power-off according to the standard procedure.

Such a pseudo power failure is distinct from a true power failure. While a true power failure usually lasts for, e.g., several minutes at the longest, a pseudo power failure caused by the AC-off may last for several days. For example, if a user turns off the AC for suspending the user's work during a weekend, the memory backup must be continued until the beginning of the next week, e.g., for several days.

However, ensuring the memory backup for such a long period requires providing a large battery device. This poses problems of an increased size of the storage system and therefore an increased cost.

### SUMMARY

In accordance with an aspect of the present embodiment, a storage control apparatus that stores backup target in a predetermined storage area of a storage apparatus includes a determination unit for determining whether or not the backup target data has been modified, and a backup processing unit for performing the backup processing for the backup target data when the determination unit determines that the backup target data has been modified.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 illustrates a storage system according to an embodiment of the present invention;

FIG. 2 illustrates an embodiment of a storage control apparatus;

FIG. 3 illustrates an embodiment of a storage management method;

FIG. 4 illustrates regular backup processing;

FIG. 5 illustrates state transitions of backup in the storage system;

FIG. 6 illustrates a sequence (No. 1) for a case where the regular backup is normally performed;

FIG. 7 illustrates a sequence (No. 2) for the case where the regular backup is normally performed;

FIG. 8 illustrates a sequence (No. 1) for a case where processing of the regular backup is terminated in the middle of the processing;

FIG. 9 illustrates a sequence (No. 2) for the case where the processing of the regular backup is terminated in the middle of the processing;

FIG. 10 illustrates a sequence for a case where reception of a Host I/O or operation of internal processing occurs after completion of the regular backup;

FIG. 11 illustrates exemplary power-off operations;

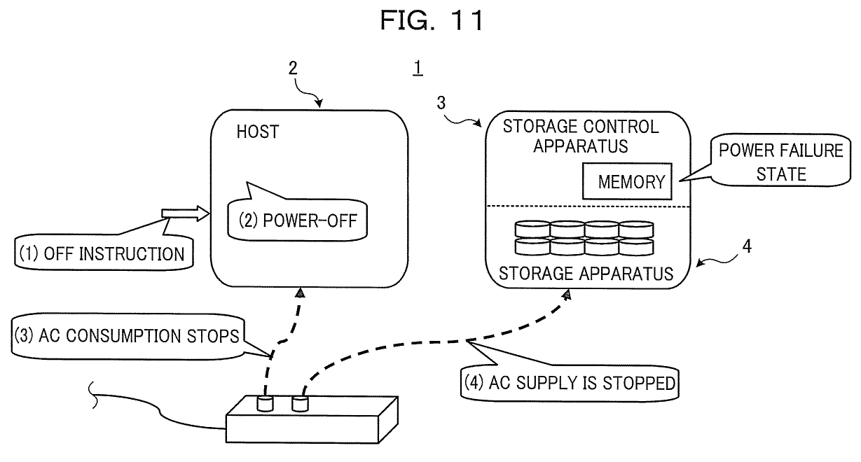

FIG. 12 illustrates an exemplary hardware configuration of the storage control apparatus and a storage apparatus; and

FIG. 13 illustrates an exemplary firmware configuration formed based on the hardware in FIG. 12.

### DESCRIPTION OF EMBODIMENTS

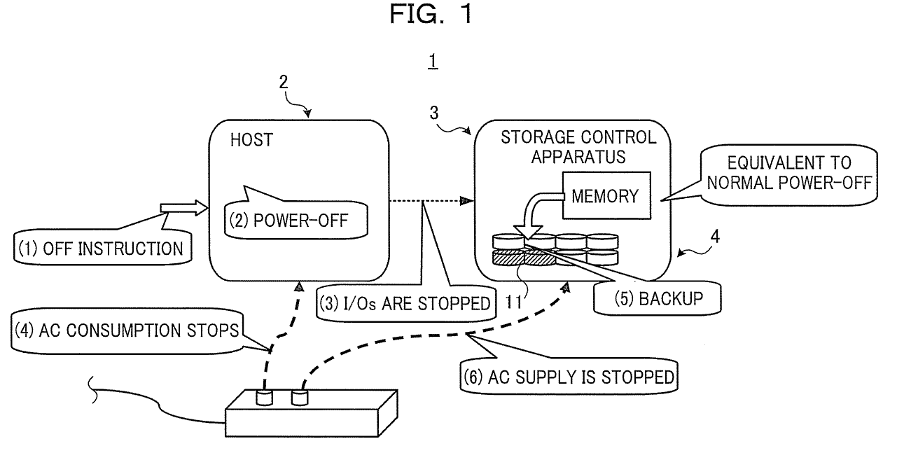

FIG. 1 illustrates a storage system 1 according to an embodiment of the present invention.

(1) A host 2 is given an OFF instruction from an operator.

(2) The host 2 performs power-off based on the instruction.

(3) The power-off by the host 2 in (2) causes a stoppage of I/Os, i.e., commands from the host 2.

(4) The power-off by the host 2 in (2) causes a stoppage of AC consumption through an outlet.

(5) A certain time after the stoppage of I/Os in (3), data in a table area (which is in memory shown in FIG. 1) is backed up to a system disk 11.

(6) A certain time after the stoppage of the AC consumption in (4), AC supply to a storage control apparatus 3 and a storage apparatus 4 is stopped by the power supply tap control.

What is particularly notable in (1) to (6) is that the backup processing in (5) is performed in response to the stoppage of I/Os from the host 2 in (3). This will be specifically described below.

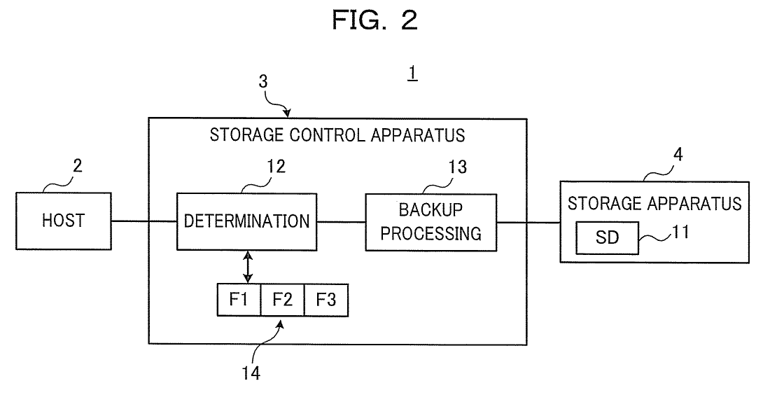

FIG. 2 illustrates an embodiment of the storage control apparatus. Hereinafter, like elements are designated with like reference numerals or symbols throughout the drawings.

The storage control apparatus 3 illustrated in FIG. 2 controls information accesses between the host 2 and the storage apparatus 4. The storage control apparatus 3 also stores backup target data requiring backup processing in a predetermined storage area, for example a system disk (SD) 11. The storage control apparatus 3 has a determination function unit 12 and a backup processing function unit 13. Preferably, the storage control apparatus 3 further has a flag area 14 formed therein.

The determination function unit 12 determines, at predetermined time intervals, whether or not the backup target data has been modified. Each time the determination function unit 12 determines that the backup target data has been modified, the backup processing function unit 13 performs backup processing for the backup target data.

Preferably, the storage control apparatus 3 further has the flag area 14, as mentioned above. The flag area 14 includes a first flag F1 indicating whether or not a command has been received from the host 2, a second flag F2 indicating whether or not internal processing related to control inside the storage control apparatus 3 has been performed, and a third flag F3 indicating whether the backup data stored in the system disk or the like is valid or invalid according to the first and second flags F1 and F2.

The determination function unit 12 refers to the flag area 14. When the third flag F3 indicates that the backup data is invalid, the backup processing function unit 13 performs the above-mentioned backup processing.

Thus, the storage system 1 according to this embodiment includes the host 2, the storage apparatus 4 to which information accesses are made by the host 2, and the storage control apparatus 3 intermediating between the host 2 and the storage apparatus 4.

Next, an embodiment of a storage management method implemented in the storage system 1 described with reference to FIG. 2 will be described.

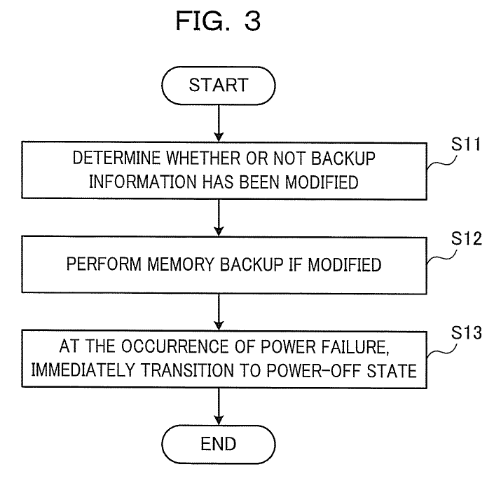

FIG. 3 illustrates a flowchart of the storage management method of the embodiment. The storage management method illustrated in FIG. 3 includes a backup step of storing the backup target data requiring the backup processing in a predetermined storage area, such as the system disk 11, while information accesses are made between the host 2 and the storage apparatus 4 via the storage control apparatus 3.

Step S11: It is determined at predetermined time intervals whether or not the backup target data written in the apparatus 3, e.g., to cache memory therein, has been modified.

Operation S12: Each time it is determined that the backup target data has been modified, the backup processing is performed for the system disk 11 in order to update the backup data stored in the system disk 11 with the backup target data.

Operation S13: When it is determined that the backup target data has not been modified when a power failure occurs, normal power-off is immediately performed without going through the memory backup state as power failure processing.

In FIG. 3, the backup target data is at least one of management data for controlling the storage apparatus 4 or user data.

In the determination operation S11 in FIG. 3, it is determined that the written backup data has been modified when any of the following events has occurred:

(i) when the storage control apparatus 3 has received a command from the host 2;

(ii) when internal processing related to control inside the storage control apparatus 3 has been performed; and

(iii) when the configuration of any of the host 2, the storage apparatus 4, and the storage control apparatus 3 has been changed (configuration change).

Further, for the backup processing operation S12 in FIG. 3, the flag area 14 is referred to in the determination operation S11. The flag area 14 sets the first flag F1 indicating whether or not the storage control apparatus 3 has received a command from the host 2, the second flag F2 indicating whether or not internal processing related to control inside the storage control apparatus 3 has been performed, and the third flag F3 indicating whether the written backup data is valid or invalid based on the first and second flags F1 and F2. When the third flag F3 indicates “invalid”, the backup processing for the system disk 11 is performed for updating the backup data stored in the system disk 11 with the backup target data.

Before performing the backup processing, it is preferable to have the operation of issuing a notification from the storage control apparatus 3 notifying that accesses to the storage apparatus 4 should be temporarily stopped.

Also, the performance of the backup processing is preferably terminated when any of the above-described events, i.e., (i) the storage control apparatus 3 receives a command from the host 2, (ii) internal processing related to control inside the storage control apparatus 3 is performed, and (iii) the configuration of any of the host 2, the storage apparatus 4, and the storage control apparatus 3 is changed, occurs during the performance of the backup processing in S12.

Further, the “predetermined time intervals” mentioned in operation S11 in FIG. 3 are predetermined certain time intervals regardless of whether or not the backup data has been modified, or upon the lapse of a predetermined certain time from the point of every occurrence of a modification in the backup data.

When the power failure in operation S13 in FIG. 3 is over and the power is recovered, the backup data subjected to the backup processing in operation S12 can be reread from the system disk 11 to start a restoration operation simultaneously with entering the power-on state after the power recovery.

Detailed examples of the storage system will be described below.

(A) Functional Overview

a1) Regular Backup

The following functions are supported for preventing the apparatus from transitioning to the normal memory backup by a battery when the apparatus enters the power failure state at power-off of the system 1.

If “Host I/Os” from the host 2 and “processing inside the apparatus” are stopped for a certain time, e.g., two to three minutes, data in a table area in memory, such as a cache, is backed up to the system disk 11. This backup processing will be called “regular backup”. The above “Host I/Os” refer to all commands issued by a CA to a CM (Basic). The CA represents a Channel/Adapter, and the CM represents a Controller Module. The “processing inside the apparatus” refers to processing that operates inside the apparatus regardless of Host I/Os, including processing of adding a new disk to an existing RAID group to extend the capacity of the RAID group (LDE), format processing for a disk (QF), encryption conversion, copy, and configuration change. The LDE represents Logic Device Extension, and the QF represents Quick Format.

When a power failure occurs after completion of the backup, transition to the memory backup by the battery is prevented.

When power recovers after a power failure, the apparatus is started up in Ready as normal power-on rather than in Resume (restart), and restoration from the system disk 11 is performed.

a2) Stopping/Resuming the Regular Backup

Considering the performance measurement and the like, it is preferable to allow the regular backup function to be stopped/resumed from an MMI (Man Machine Interface).

(B) Operational Conditions

The regular backup operates only if the following conditions are satisfied.

No Host I/Os have been received for the certain time.

Processing inside the apparatus has been stopped for the certain time.

The apparatus is in the Ready state.

No dirty data (including pin data) exists.

The system disk 11 is available, that is, both mirrored disks are not locked.

The regular backup function is preferably not in a stop state (as instructed from the MMI to stop). It is to be noted that if one CM in a dual CM configuration is disconnected due to an abnormal condition or the like, the regular backup is operated.

(C) Control Method

c1) Control Flags

The regular backup is controlled based on the following three flags.

a flag indicating the reception state of Host I/Os and Copy I/Os (an I/O reception flag)=the above-described flag F1

setting: the CA/Basic set the flag (Copy I/Os).

The Copy I/Os mean I/Os for copy processing of processing inside the apparatus.

reference: a System Control refers to the flag.

clear: the System Control clears the flag.

a flag indicating the operation state of processing inside the apparatus (an internal processing flag)=the above-described flag F2

setting: the Basic

reference: the System Control

clear: the System Control

a flag indicating the validity of the backup data (a backup flag)=the above-described flag F3

setting: the System Control (at the completion of the backup)

reference: the System Control and the Kernel

clear: The CA/Basic (at the time when the I/O reception flag/the internal processing flag is set to ON), and the System Control

c2) Process Flow

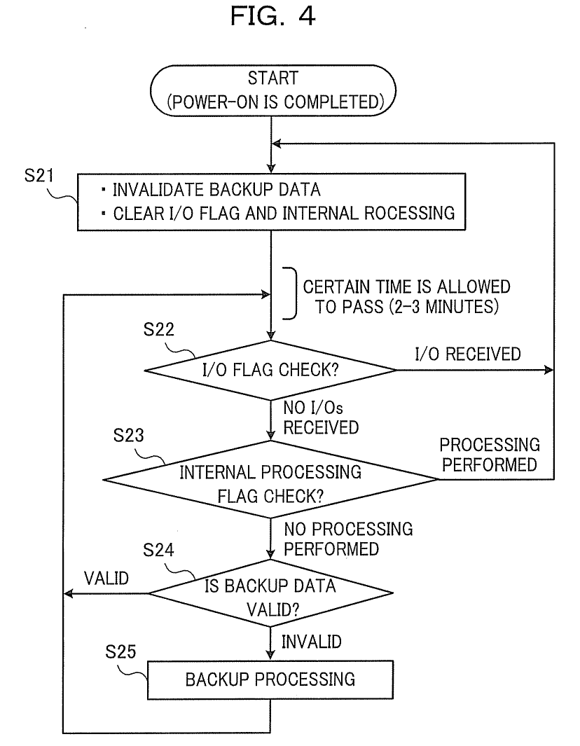

Here, a schematic process flow of the regular backup will be described with reference to FIG. 4.

Operation S21: The backup data is invalidated, and the I/O flag and the internal processing flag are cleared. The certain time, e.g., two to three minutes, is allowed to pass.

Operation S22: The I/O flag is checked. If an I/O has been received, the process returns to operation S21.

Operation S23: If no I/Os have been received in operation S22, the internal processing flag is checked. If internal processing has been performed, the process returns to operation S21.

Operation S24: If no internal processing has been performed in operation S23, it is determined whether the backup data is valid or not. If valid, i.e., if there is no change, the process returns to operation S22.

Operation S25: If it is determined in operation S24 that the backup data is invalid, the backup processing is performed.

(D) Transitions of the Backup State

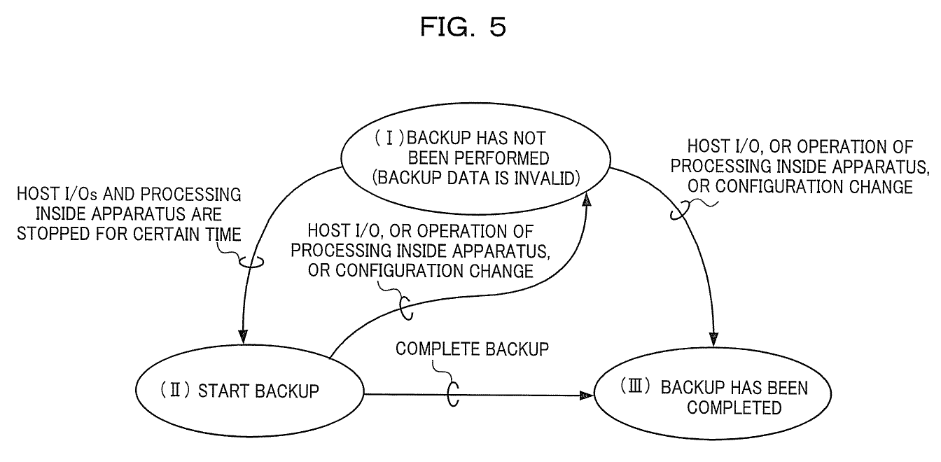

Referring here to FIG. 5, the backup state transitions as in FIG. 5 depending on the states of Host I/Os, processing inside the apparatus, and a configuration change.

(I) is a state where “the backup has not been performed or the backup data is invalid”. In this state, if Host I/Os and processing inside the apparatus are stopped for the certain time, the state transitions to the next state.

(II) is a state where “the backup processing is started”. In this state, if any of a Host I/O, operation of processing inside the apparatus, and a configuration change occurs, the state returns to the original state (I). Otherwise, the backup is completed and the state transitions to the next state.

(III) is a state where “the backup processing has been completed”. In this state, if any of a Host I/O, operation of processing inside the apparatus, and a configuration change occurs, the state again returns to the above state (I).

Further, in FIG. 5,

if any of reception of a Host I/O, operation of internal processing, and a configuration change occurs during the backup processing (II), the backup processing is immediately terminated and the backup data is invalidated (“invalid” in S24 in FIG. 4), and

if any of reception of a Host I/O, operation of internal processing, and a configuration change occurs after completion of the backup processing (III), the backup data is invalidated (“invalid” in S24 in FIG. 4).

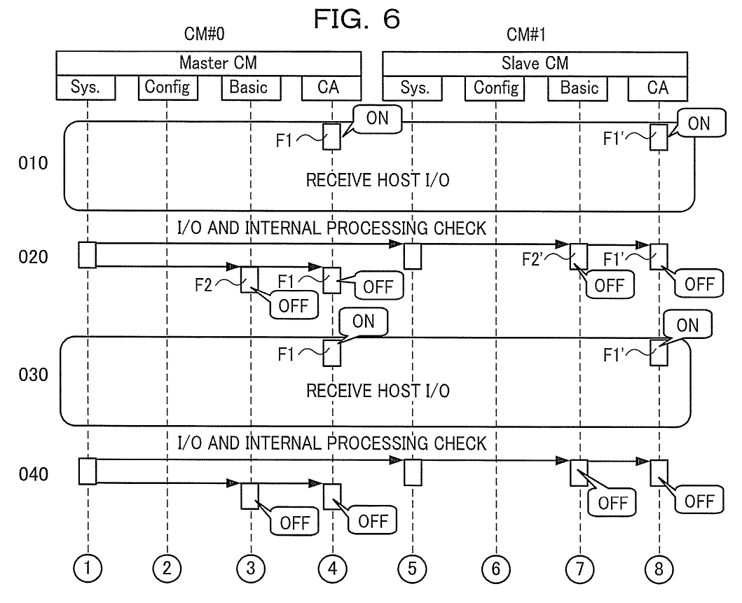

Next, more detailed examples will be described with reference to FIGS. 6 to 10. A brief description will be given of a firmware (FW) configuration underlying FIGS. 6 to 10 and a hardware (HW) configuration on which this firmware is formed.

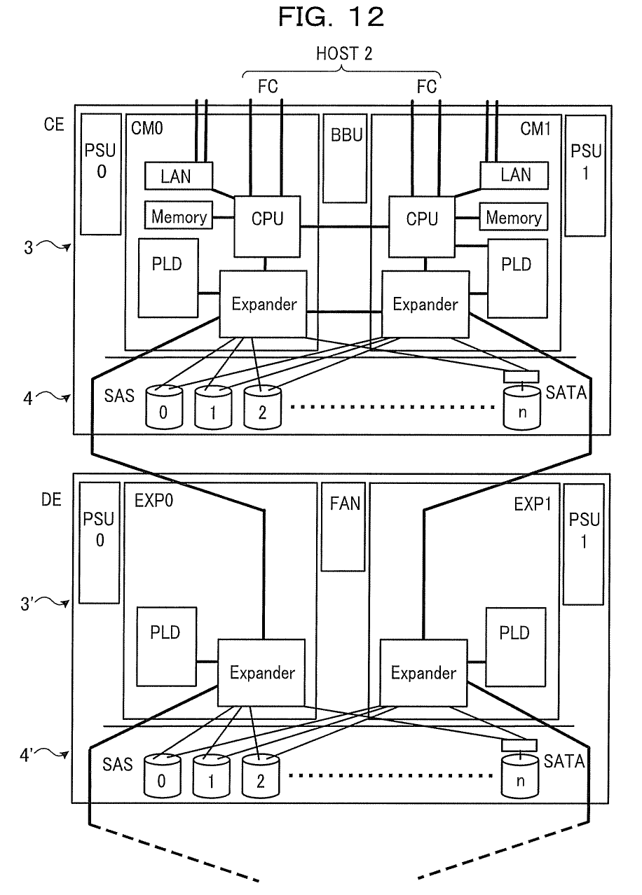

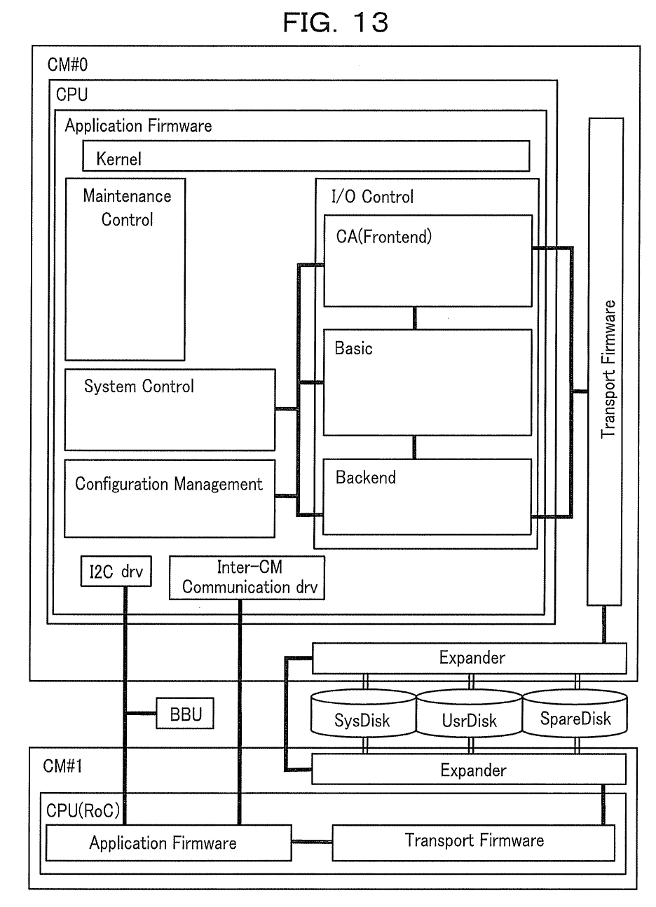

FIG. 12 illustrates an exemplary hardware configuration of the storage control apparatus 3 and the storage apparatus 4. FIG. 13 illustrates an exemplary firmware configuration formed based on the hardware in FIG. 12.

Referring to FIG. 12, a CE (Controller Enclosure) is disposed in the upper layer and a DE (Drive Enclosure) is disposed in the lower layer in FIG. 12. Both of the CE and the DE have a dual redundant configuration. That is, the CE includes a CM0 (Controller Module) and a CM1 and exchanges data with the host 2 through respective FCs (Fibre Channels).

In CM0 (also in the CM1), a CPU is responsible for the overall control. This CPU cooperates with memory in FIG. 12. The memory includes a cache and the like. The memory also includes flash memory and the like in which the flags (F1, F2, and F3) are formed. A battery for backing up this memory is shown as a BBU (Battery Backup Unit).

The storage apparatus 4 includes disks having a SAS-standard interface, and disks having a SATA-standard interface. It is to be noted that the system disk (SD) 11 (FIGS. 1 and 2) is not shown here. The meanings of symbols in FIG. 12 are as follows.

CM: Controller Module

PSU: Power Supply Unit

BBU: Battery Backup Unit

PLD: Programmable Logic Device

EXP: Expander Module

SAS: Serial Attached SCSI

SATA: Serial Advanced Technology Attachment

FIG. 13 also illustrates the CM0, CM1, CPU, BBU, and the like in FIG. 12 and the system disk 11 in FIGS. 1 and 2. The CM0 and the CM1 stored in the left and right in the CE in FIG. 12 are shown in FIG. 13 in the upper and lower layers as a CM#0 and a CM#1, respectively.

In FIG. 13, the “System Control” (Sys.), “Configuration Management” (Config.), “Basic”, and CA (Channel Adapter) are particularly relevant to the description of FIGS. 6 to 10 to be provided later.

The CA (Frontend) serves as an interface with the host 2 and mainly receives data and commands from the host 2. While the received data is managed in the Basic and written to the disks (4), the data is held in the cache. Alternatively, the disks (RAID) 4 are managed in the Basic.

The Backend performs a control of actually reading/writing data from/to the disks 4. This read/write control and the disk management by the Frontend are performed through “Transport Firmware”.

The “System Control” (Sys.) mainly controls and manages the inside of the apparatus 3 (FIGS. 1 and 2). The “Configuration Management” (Config.) manages configuration information (addition, removal, etc.) about the host 2 and the apparatuses 3 and 4.

Now, more specific detailed examples will be described with reference to FIGS. 6 to 10.

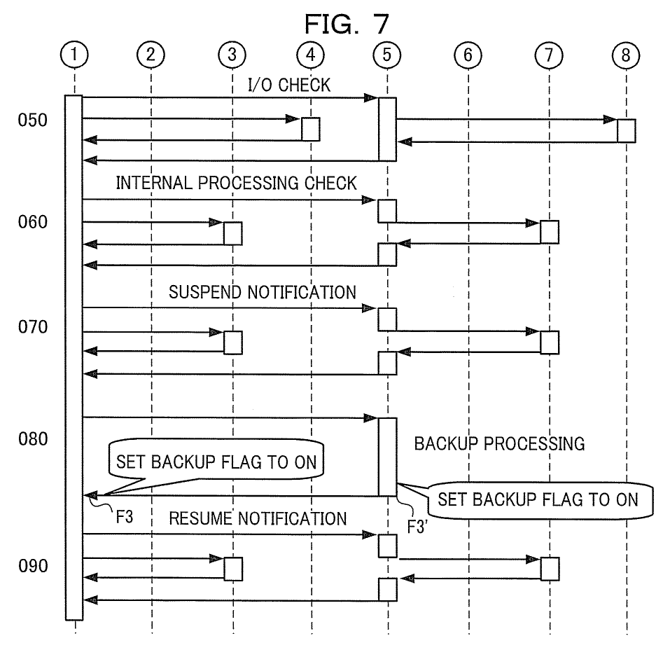

FIG. 6 illustrates a sequence (No. 1) for a case in which the regular backup is normally performed. FIG. 7 illustrates another sequence (No. 2) for the case in which the regular backup is normally performed. Numerals 010, 020, 030, . . . in the leftmost portion of FIGS. 6 and 7 indicate chronological stages.

Stage 010: The CA on the master side receives a Host I/O from the host 2, so that the flag F1 is set to ON. In synchronization with this, the flag F1′ on the slave side is also set to ON.

Stage 020: To check for subsequent I/O reception and to check for internal processing, the System Control (Sys.) clears the corresponding flags F1 and F2 (sets the flags to OFF). The same applies to the slave side.

Stage 030: As in stage 010, the flag F1 is set to ON because a Host I/O has been received. The same applies to the slave side.

Stage 040: The same is performed as in stage 020.

Stage 050: Upon the lapse of the above-described certain time after clearing the flags in stage 040, the Sys. again checks for I/Os (S22 in FIG. 4). In the case of FIG. 7, the flag F1 remains set to OFF because no I/Os have been received. That is, I/Os have been stopped. At this point, it is confirmed through the Sys. on the slave side that the flag F1′ on the slave side is also OFF.

Stage 060: Subsequently, the Sys. queries the Basic to check for internal processing (S23 in FIG. 4). The same check is also performed on the slave side through the slave-side Basic.

Stage 070: Having undergone stages 050 and 060, the Sys. determines that the regular backup can be performed. The Sys. then provides a Suspend notification to the Basic. Also on the slave side, the Sys. provides a Suspend notification to the Basic. This is for instructing a temporary stop of other processing in the apparatus, e.g., accesses to the cache memory, because the regular backup is now going to be performed.

Stage 080: The Sys. performs the “backup processing” for writing the backup target data in the cache memory to the system disk 11. In response to the completion of this backup processing, the backup flag F3 is set to ON. The flag F3′ on the slave side is also set to ON. Setting the flag F3 (F3′) to ON indicates that the content of the system disk 11 has been updated to the latest backup data.

If a power failure occurs at this point, the Sys. firstly checks its flag F3. If it is confirmed that F3=ON, the Sys. can immediately enter the power-off state without transitioning to the conventional memory backup.

Stage 090: A Resume notification is provided to the Basic, indicating that the Suspend instructed by the Sys. in stage 070 can be cleared. Thereafter, the process returns to operation S22 in FIG. 4 to repeat the same operations.

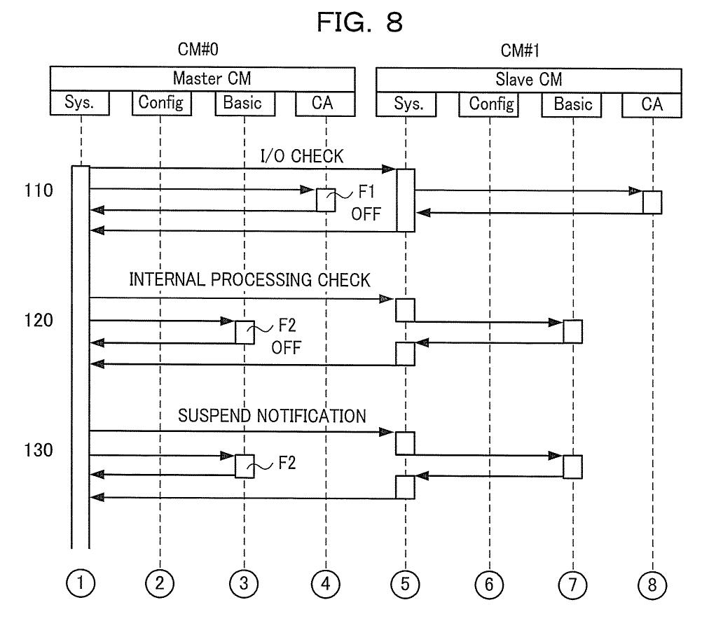

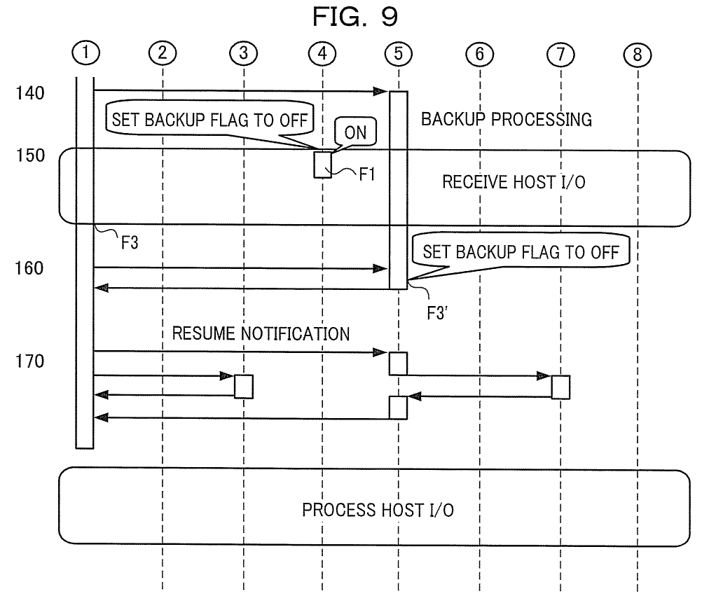

FIG. 8 illustrates a sequence (No. 1) for a case where the processing of the regular backup is terminated in the middle of the processing. FIG. 9 illustrates another sequence (No. 2) for the case where the processing of the regular backup is terminated in the middle of the processing. The case of FIGS. 8 and 9 may be a case in which reception of a Host I/O or operation of processing inside the apparatus occurs during the processing of the regular backup.

Stage 110: Upon the lapse of the “certain time”, the Sys. checks for I/Os (S22 in FIG. 4). In the case of FIG. 8, the flag F1 is OFF because no I/Os have been received in the CA. That is, I/Os have been stopped.

Stage 120: Subsequently, the Sys. checks for internal processing (S23 in FIG. 4). Since “no” internal processing has operated in the case of FIG. 8, the flag F2 is set to OFF by the Basic. That is, internal processing has also been stopped.

Stage 130: The Sys. determines that the regular backup can be performed and provides a Suspend notification to the Basic (as in stage 070).

Stage 140: After instructing Suspend in stage 130, the Sys. starts the “backup processing” and therefore starts writing the backup target data in the cache memory to the system disk 11.

Stage 150: It is assumed that a Host I/O is received by the CA during the writing of the backup target data. The CA immediately sets the flag F1 to ON. In conjunction with the setting of the flag F1 to ON, the backup flag F3 is switched from ON to OFF.

Stage 160: In response to the switching of the flag F3 from ON to OFF, the Sys. issues an instruction to terminate the backup in progress. At this point, the flag F3′ on the slave side is also set to OFF. The backup is now terminated.

Stage 170: The Sys. further clears Suspend in stage 130 to provide a Resume notification to the Basic, and continues with processing of the Host I/O received in stage 150.

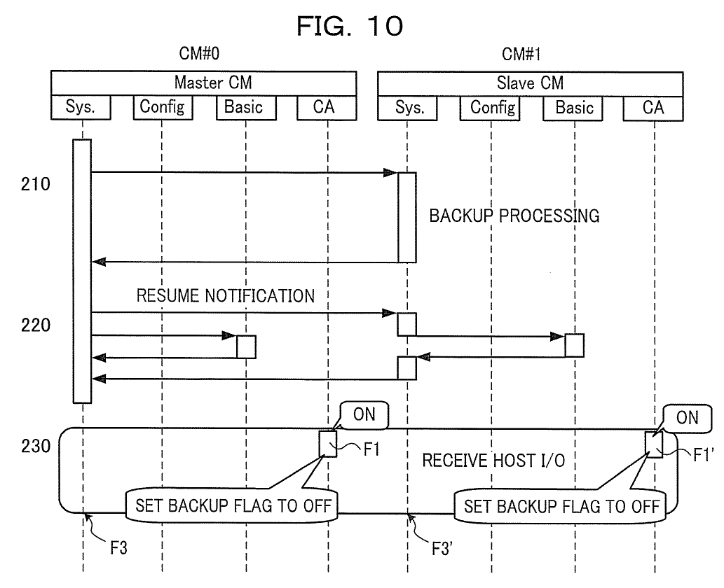

FIG. 10 is a sequence diagram for a case where reception of a Host I/O or operation of internal processing occurs after completion of the regular backup.

FIG. 10 illustrates the case as follows. The “backup processing” has been completed in stage 080 in FIG. 7, but immediately after that, the state transitions to the case in which reception of a Host I/O or operation of internal processing occurs. Therefore, the once valid backup data becomes invalid. In other words, this case corresponds to “invalid” in operation S24 in FIG. 4.

Stage 210: The Sys. performs the backup processing.

Stage 220: After performing the backup processing, the Sys. provides a Resume notification to the Basic.

Stage 230: Immediately after the Resume notification, the CA receives a Host I/O and therefore switches the flag F1 to ON. In conjunction with the switching of the flag F1, the backup flag F3 is also switched to OFF.

Thus, if a power failure occurs immediately after this, the Sys. first checks the flag F3. Since the flag F3 has now been switched to OFF, the backup data is invalid. In this case, the normal memory backup by the battery will be performed.

(E) Power-Off/On

e1) Power-off/on after completion of the backup is controlled as follows, for example.
Operation 1: The backup processing is completed.
Operation 2: The apparatus is powered off (backup is performed).
Operation 3: The apparatus is powered on (data at the power-off is restored).

e2) Power-off during the backup processing is addressed as follows, for example.
Operation 1: The backup processing is started.
Operation 2: Power-off is detected.
Operation 3: The backup processing is terminated (termination is waited for).
Operation 4: Power-off processing is performed (backup is performed).
Operation 5: The apparatus is powered on (data at the power-off is restored).

(F) Power Failure/Power Recovery

Depending on the state of the backup data at the occurrence of a power failure, the following operations are performed, for example. Although the operable period at the occurrence of a power failure is about 2.5 [ms], the operable period is restrained to be about 1 [ms] or less for the firmware (FW).

f1) The following operations are performed for a power failure/power recovery after completion of the backup.
Operation 1: The backup processing is completed.
Operation 2: A power failure occurs (the battery stops being discharged or remains discharged).
Operation 3: The apparatus is powered on (data backed up in operation 1 is restored).

f2) If a power failure occurs during the backup processing, the following is performed, for example.
Operation 1: The backup processing is started.
Operation 2: A power failure occurs (the memory backup by the battery is performed).
Operation 3: The apparatus is powered on (started up in Resume).

(G) If a Power Failure Occurs when the Backup has Not Been Performed, It Results in a Normal Power Failure as Follows, for Example.

Operation 1: An I/O is being processed.

Operation 2: A power failure occurs (the memory backup by the battery is performed).

Operation 3: The apparatus is powered on (started up in Resume).

(H) Examples of Various Sorts of Error Processing During Processing of and After Completion of the Backup will be Described Below.

h1) abnormal conditions in a CM (Controller Module)
h11) If an abnormal condition in a CM, such as CM restart processing, occurs during the backup processing, the backup processing is terminated and the backup data is invalidated.
h12) If the CM restart processing occurs when the backup has been completed, the backup data is invalidated.
h13) If CM disconnection processing occurs when the backup has been completed, the backup data is invalidated as in the case of the CM restart processing.

h2) abnormal conditions in the system disk
h21) For an abnormal condition on one of the disks (one of the mirrored disks) during the backup processing, the backup processing is simply continued.
h22) For an abnormal condition on both disks (both mirrored disks) during the backup processing, the backup processing is terminated because data cannot be held. The backup data is invalidated.
h23) For an abnormal condition on one of the disks after completion of the backup, the backup state is maintained as it is.
h24) For an abnormal condition on both disks after completion of the backup, the backup data is invalidated.

(I) Interfaces (Examples)

i1) Internal Interfaces

The following library and interfaces are necessary for the regular backup function.
i11) When a Host I/O is received, the Host I/O reception flag F1 is set by the CA.
i12) The System Control checks the host I/O reception state.
i13) When processing inside the apparatus operates, the internal processing operation flag F2 is set by the Basic.
i14) When processing inside the apparatus operates, a notification is provided to an internal processing operation system control.
i15) The System Control checks the operation state of processing inside the apparatus.
i16) At the occurrence of a power failure, the System Control notifies the CM Kernel of the backup state.

The storage management system detailed above can be condensed as follows. In a conventional storage system, whenever a power failure occurs, the power failure processing is performed even in a static state with no Host I/Os or the like flowing. That is, the system is caused to transition to the memory backup state in which data can only be backed up as long as the battery remains.

However, in the system disclosed herein, if Host I/Os are stopped for more than a certain time, management data and the like requiring backup is backed up to the disk 11 beforehand. In this manner, if the data is already saved in the disk 11 at a power failure, the system can be normally powered off without the need to perform the backup operation again. That is, the system is not caused to transition to the memory backup state. Therefore, when the power is recovered, the restoration operation based on normal power-on processing can be performed. Thus, the system startup time can be reduced, and the need for a large backup battery can also be eliminated.

Features of control for this can be summarized as follows.

If Host I/Os are stopped for a certain time, management information and the like requiring backup is backed up to the disk 11 beforehand.

At the occurrence of an actual power failure, it is automatically checked whether a change has occurred in the state inside the apparatus since the point of the backup to the disk 11. If no change has occurred, normal power-off processing is performed without performing the memory backup processing as power failure processing. In the case of the memory backup, backup data at the point of the power failure would be lost upon exhaustion of the battery. However, if a power failure occurs with the data backed up beforehand as described above, the system transitions to the normal power-off. Therefore, no matter how many hours pass, the backup data is never lost.

At the occurrence of an actual power failure, it is automatically checked whether a change has occurred in the state inside the apparatus since the point of the backup to the disk 11. If a change has occurred, the power failure processing is performed.

Thus, since the firmware automatically selects a backup method according to the state of the apparatus, the system operator does not need to take any special actions.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

1. A storage management method for storing backup target data in a predetermined storage area of a storage apparatus, comprising:
determining whether or not the backup target data has been modified;
performing a backup processing for the backup target data when it is determined that the backup target data has been modified; and
changing a state to power-off state at the occurrence of a power failure without performing the backup processing when it is determined that the backup target data has not been modified after the performance of the backup processing.

2. The storage management method according to claim 1, wherein
the backup target data is management data for controlling a storage apparatus or user data.

3. The storage management method according to claim 1, wherein
the determining comprises determining that the backup target data has been modified when any of the following events has occurred: when a storage control apparatus has received a command from a host; when internal processing related to control inside the storage control apparatus has been performed; and when the configuration of any of the host, the storage apparatus, and the storage control apparatus has been changed.

4. The storage management method according to claim 3, wherein
the performing a backup processing includes referring to a validity flag indicating whether the backup data stored in the storage apparatus is valid or invalid and performing the backup processing if the flag indicates invalid.

5. The storage management method according to claim 4, wherein
the validity flag is set according to a command reception flag indicating whether or not a command has been received from the host, and an internal processing flag indicating whether or not internal processing related to control inside the storage control apparatus has been performed.

6. The storage management method according to claim 1, further comprising
issuing, before the performing, a notification from a storage control apparatus notifying that accesses to the storage apparatus should be temporarily stopped.

7. The storage management method according to claim 1, wherein
the backup processing is terminated when any of the following events occurs during performing the backup processing: when a storage control apparatus receives a command from the host; when internal processing related to control inside the storage control apparatus is performed; and when the configuration of any of the host, the storage apparatus, and the storage control apparatus is changed.

8. The storage management method according to claim 1, wherein
the step of determining is performed at predetermined time intervals regardless of whether or not the backup target data has been modified.

9. The storage management method according to claim 1, wherein
the step of determining is performed upon the lapse of a predetermined time from the point of every occurrence of a modification in the backup target data.

10. A storage control apparatus that stores backup target data in a predetermined storage area of a storage apparatus, comprising:
a determination unit determining whether or not the backup target data has been modified; and
a backup processing unit performing the backup processing for the backup target data when the determination unit determines that the backup target data has been modified.

11. The storage control apparatus according to claim 10, wherein
the backup target data is management data for controlling the storage apparatus or user data.

12. The storage control apparatus according to claim 10, wherein
the determination unit determines that the backup target data has been modified when any of the following events has occurred: when a storage control apparatus has received a command from a host; when internal processing related to control inside the storage control apparatus has been performed; and when the configuration of any of the host, the storage apparatus, and the storage control apparatus has been changed.

13. The storage control apparatus according to claim 12, wherein
the backup processing unit refers to a validity flag indicating whether the backup data stored in the storage apparatus is valid or invalid and performs the backup processing if the flag indicates invalid.

14. The storage control apparatus according to claim 13, wherein
the validity flag is set according to a command reception flag indicating whether or not a command has been received from the host, and an internal processing flag indicating whether or not internal processing related to control inside the storage control apparatus has been performed.

15. The storage control apparatus according to claim 10, further comprising
a notification unit issuing, before the backup processing, a notification from a storage control apparatus notifying that accesses to the storage apparatus should be temporarily stopped.

16. The storage control apparatus according to claim 10, wherein
the backup processing is terminated when any of the following events occurs during the performance of the backup processing: when a storage control apparatus receives a command from the host; when internal processing related to control inside the storage control apparatus is performed; and when the configuration of any of the host, the storage apparatus, and the storage control apparatus is changed.

17. The storage control apparatus according to claim 10, wherein
the determination unit performs the determination processing at predetermined time intervals regardless of whether or not the backup target data has been modified.

18. The storage control apparatus according to claim 10, wherein
the determination unit performs the determination processing upon the lapse of a predetermined time from the point of every occurrence of a modification in the backup target data.
